(19) United States
(12) Patent Application Publication
(10) Pub. No.: US 2025/0306278 A1
(43) Pub. Date: Oct. 2, 2025

(54) CUTTING DEVICE

(71) Applicant: FURUKAWA ELECTRIC CO., LTD., Tokyo (JP)

(72) Inventors: Akihiro Komatsuzaki, Tokyo (JP); Tomohiro Akiyama, Tokyo (JP)

(21) Appl. No.: 19/236,203

(22) Filed: Jun. 12, 2025

Related U.S. Application Data
(63) Continuation of application No. PCT/JP2023/045960, filed on Dec. 21, 2023.

(30) Foreign Application Priority Data
Dec. 27, 2022 (JP) 2022-209905

(51) Int. Cl. G02B 6/25

(52) U.S. Cl. CPC G02B 6/25

(57) ABSTRACT

A support part is disposed so as to be changeable in height with respect to a base, and supports a blade member. The support part is pressed, by an elastic member, upward relative to the base. A positioning member is fixed to the base, and thus the blade member fixed to the support part is pressed above the positioning member. When the support part is lowered by a support part lowering mechanism, contact between a tapered part of the blade member and the positioning member is released. Thus, friction between the blade member and a projection is removed, and the blade member can be rotated by a rotation mechanism.

### TECHNICAL FIELD

The present invention relates to a cutting device for cutting an optical fiber.

### BACKGROUND OF THE INVENTION

When an optical fiber is to be fusion spliced, conventionally, coating of an optical fiber core is removed first and then the optical fiber is cut into predetermined size. As a cutting device for cutting the optical fiber, there has been a device that removes the coating of the optical fiber core to expose a glass fiber portion and scratches a surface of the glass fiber portion by contacting a disc-shaped blade member to cut the optical fiber.

However, in the above-mentioned cutting device, the blade member may be deteriorated due to repeated contact with the optical fiber. Thus, a device in which a contact position with the optical fiber can be replaced by rotating the blade member during cutting operation has been proposed.

As such the cutting device, Japanese Unexamined Patent Application Publication No. 2008-203815 (JP-A-2008-203815), for example, has proposed a device in which a contact position with the optical fiber can be replaced by rotating the blade member in conjunction with movement of the disc-shaped blade member during cutting operation, for example.

Here, if a rotational axis of the circular blade member is at a perfect center of the blade member, the position of the blade member does not change even when the blade member is rotated. Thus, even if the blade member is rotated in use, relative relationship thereof with the optical fiber can always be kept constant and a consistent scratch can be made to the optical fiber.

However, because of manufacturing accuracy of the blade member or the like, the rotational axis of the blade member may become off-center and eccentric. In such the case, if the blade member is rotated in use, the position of the blade member changes due to the rotation of the blade member. This changes depth of the scratch made to the optical fiber. If the scratch depth changes in this way, it becomes difficult to cut the optical fiber with high precision, thereby deteriorating cutting quality of the optical fiber.

In contrast, Japanese Unexamined Patent Application Publication No. 2018-163195 (JP-A-2018-163195) has proposed a cutting device in which the blade member can be positioned at proximity of a blade tip of the blade member by bringing a tapered-shaped positioning portion into contact with a tapered portion of the disc-shaped blade member. According to JP-A-2018-163195, a blade-tip position of the blade member can be restricted with higher precision even when the rotational axis of the blade member is eccentric.

Unfortunately, JP-A-2018-163195 has an issue that, since the blade member is pressed against the positioning portion, large force is required to rotate the blade member, which deteriorates operability. However, if the pressing force of the blade member against the positioning portion is weakened, the blade member is more likely to become misaligned or rotate, resulting in poor positioning precision, and, at the same time, the blade member may rotate unintentionally.

Such the change in position and unintentional rotation of the blade member may cause inconsistent scratch position and depth in the optical fiber. This makes it difficult to cut the optical fiber with high precision and deteriorates the cutting quality of the optical fiber. Thus, a structure that allows the blade member to be positioned with high precision and to be rotated more easily and reliably at the same time has been awaited.

### SUMMARY OF THE INVENTION

The present invention was made in view of the above-mentioned problems. It is an object of the present invention to provide a cutting device that allows a blade member to be positioned with higher precision and to be rotated easily.

To achieve the above object, an aspect of the present invention is a cutting device for cutting an optical fiber including a base, a disc-shaped blade member, a positioning member that is provided on the base and restricts a position of the blade member, a support part that is disposed so as to be changeable in height with respect to the base and supports the blade member, a first elastic member that presses the support part to a positioning portion of the positioning member with respect to the base, a support part lowering mechanism that is provided on the main body and can push down the support part in a direction opposite to the positioning portion, and a rotation mechanism that allows the blade member to rotate. The positioning member includes a slit. The blade member is stored inside the positioning member. The first elastic member presses the blade member toward the slit so that a tapered portion of the blade member is positioned by coming into contact with the positioning portion on an inner surface side of the slit. A tip of the blade member protrudes to a surface side of the slit. When the support part lowering mechanism lowers the support part to release the contact between the tapered portion of the blade member and the positioning portion, the rotation mechanism can rotate the blade member.

The cutting device may include a handling portion for moving the support part with respect to the main body. When the handling portion moves the support part by a predetermined distance or more, the support part lowering mechanism may come into contact with a part of the support part so as to push down the support part.

The support part may be movable between a first position, which is a standby position before cutting, and a second position, which is a position after cutting. The handling portion may be able to push the support part into the main body from the second position to the first position. When the handling portion excessively moves the support part beyond the first position, the support part lowering mechanism may come into contact with a part of the support part so as to push down the support part.

The rotation mechanism may include a first gear that is fixed to the blade member and a second gear that meshes with the first gear and can rotate the first gear. It is preferable that the first gear and the second gear mesh with each other whether the support part is lowered or not lowered by the support part lowering mechanism.

The cutting device may include a rotation restriction member that is to be pressed against the first gear or the second gear. The rotation restriction member may include a hook that meshes with the first gear or the second gear, and the rotation restriction member may be able to restrict a rotation direction of the first gear or the second gear to a fixed direction.

The rotation restriction member may be able to define a rotational position for each tooth pitch of the first gear or the second gear. The second gear may include a display unit for indicating the rotational position of the blade member.

The cutting device may further include a second elastic member that presses the blade member toward the support part in an axial direction of the blade member. A projection may be formed as the positioning portion on one of facing edges of the slit so as to project toward an inner surface side, and the projection may be formed at two places with an axis of the blade member therebetween when viewed from above. It is preferable that the second elastic member presses the blade member such that one surface of the blade member is in surface-contact with the inner surface of the positioning member, and the first elastic member presses the blade member toward the slit so that a tapered portion on the other surface of the blade member is positioned by being in point-contact with each projection.

The cutting device may further include a guide mechanism that can move the support part downward while maintaining a posture of the support part when the support part lowering mechanism lowers the support part.

According to the present invention, in a case in which the blade member is positioned by being pressed against the positioning member, the contact between the blade member and the positioning portion can be released by pushing down the support part to rotate the blade member. Thus, the blade member can be easily rotated.

At this time, the support part is moved by the handling portion, which is used when using the cutting device, to allow the rotation mechanism to operate. This requires no special operation and facilitates the work.

Also, when the handling portion is pushed in for use, rotation of the rotation mechanism is restricted in the first position and the second position, which are normal usage states, and the rotation mechanism is rotatable only when the handling portion is pushed further beyond the first position. This can prevent the blade member from accidentally rotate during normal use.

Also, by using the rotation restriction member that restricts the rotation direction of the gears configuring the rotation mechanism, the blade member can be rotated in one direction, and this prevents the blade member from returning to an old cutting part when being rotated.

Also, the rotation restricting member can regulate the rotational position for each tooth pitch of the gears, and this makes it possible to easily acknowledge the rotational position of the blade member. Also, the gear is provided with the display unit that can indicate the rotational position of the gear. This makes it possible to easily acknowledge the timing for replacement of the blade member.

Also, the second elastic member presses the blade member to the inner surface of the positioning member so that the blade member can be in surface contact with the inner surface of the positioning member with certainty. By bringing the one surface of the blade member into surface-contact with the inner surface of the positioning member, the axial orientation of the blade member can be regulated with certainty. That is, the orientation of the blade portion of the blade member with respect to the optical fiber can be kept constant. Also, the tapered portion on the other surface of the blade member is in point-contact with each of the projections at two positions of the positioning member such that the blade member can be positioned with precision.

Also, providing the guide mechanism can prevent the support part from tilting or getting misaligned when moving downward.

The present invention can provide a cutting device that allows a blade member to be positioned with higher precision and to be rotated easily.

### BRIEF DESCRIPTION OF DRAWINGS

FIG. 1 is a perspective view showing a cutting device 1.

FIG. 2A is an upper perspective view of a cutting unit 9.

FIG. 2B is a lower perspective view of the cutting unit 9.

FIG. 3A is a perspective view of a back side of the cutting unit 9.

FIG. 3B is a plan view of the cutting unit 9.

FIG. 4 is a schematic view showing a positioning mechanism of a blade member 19.

FIG. 5A is an exploded perspective view of the blade member 19 and positioning members 15a and 15b.

FIG. 5B is an enlarged view of a section E in FIG. 5A.

FIG. 6A is a perspective view of the positioning member 15b when the blade member 19 and the positioning members 15a and 15b are assembled.

FIG. 6B is an enlarged view of a section F in FIG. 6A.

FIG. 7A is a perspective view showing a positional relationship between the blade member 19 and projections 35.

FIG. 7B is a plan view showing the positional relationship between the blade member 19 and the projections 35.

FIG. 8A is a view showing a moving state of the cutting unit 9 (a support part 25) with respect to the main body 3.

FIG. 8B is a view showing a moving state of the cutting unit 9 (the support part 25) with respect to the main body 3.

FIG. 8C is a view showing a moving state of the cutting unit 9 (the support part 25) with respect to the main body 3.

FIG. 9A is a view showing a moving state of the blade member 19

FIG. 9B is a view showing a moving state of the blade member 19.

### DETAILED DESCRIPTION

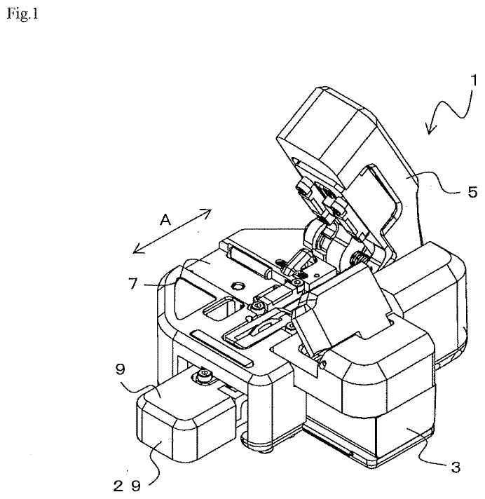

Hereinafter, embodiments of the present invention will be described with reference to the accompanying drawings. FIG. 1 is a perspective view showing a cutting device 1. The cutting device 1 mainly includes a main body 3, a lid portion 5, a cutting unit 9, and so on. The cutting device 1 is a device for cutting an optical fiber at a predetermined position.

A holder-mounting portion 7 is formed on an upper surface of the main body 3. A holder holding the optical fiber is to be mounted on the holder-mounting portion 7. A glass fiber portion that has been exposed by removing a coating of the optical fiber protrudes from an end of the holder. When the holder is disposed on the holder-mounting portion 7, the optical fiber is disposed striding over a moving range of the cutting unit 9.

In a normal state, a handling portion 29 of the cutting unit 9 protrudes from the main body 3. When the handling portion 29 is pushed into the main body 3 from such the state, the cutting unit 9 moves inside the main body 3. At this time, since the cutting unit 9 is pressed in a direction to be pushed out from the main body 3 by an elastic member, the cutting unit 9 is pushed inside the main body 3 against pressing force of the elastic member. When the cutting unit 9 is pushed in completely, a blade tip of the cutting unit 9 moves to a rear side beyond the optical fiber. In such the state, the cutting unit 9 is held by a locking portion, which is not shown.

If the lid portion 5 is closed in such the state, the locking portion that has held the cutting unit 9 is released and the above-mentioned elastic member pushes the cutting unit 9 out from the main body 3. That is, the cutting unit 9 moves. That is, the cutting unit 9 is movable in both ways of a direction A in the drawing. When the cutting unit 9 moves, the blade tip comes into contact with the optical fiber, scratching the optical fiber, and the optical fiber can be cut by applying bending stress or the like to the scratched part.

As above, the cutting unit 9 (the handling portion 29) is normally kept protruding from the main body 3 and is pushed into the main body 3 when in use. In this way, the cutting unit 9 can be easily pushed in when the main body 3 is placed on a desk or the like to be operated, for example.

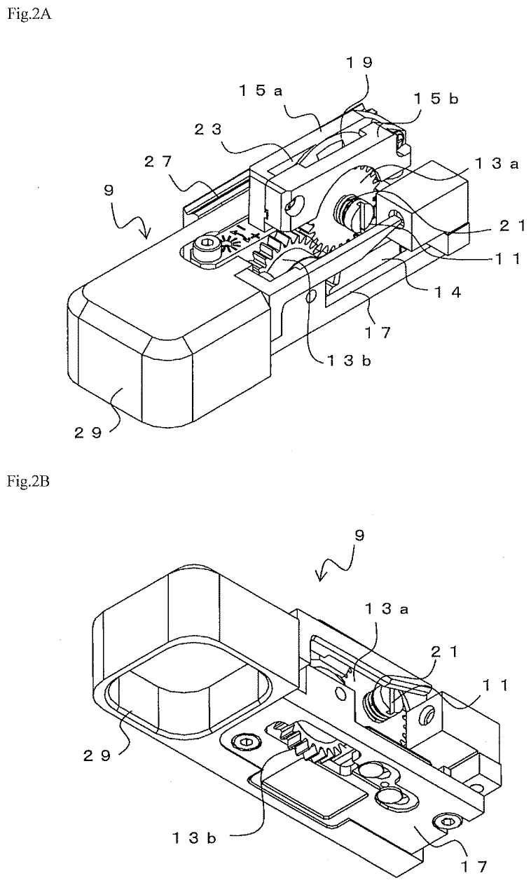

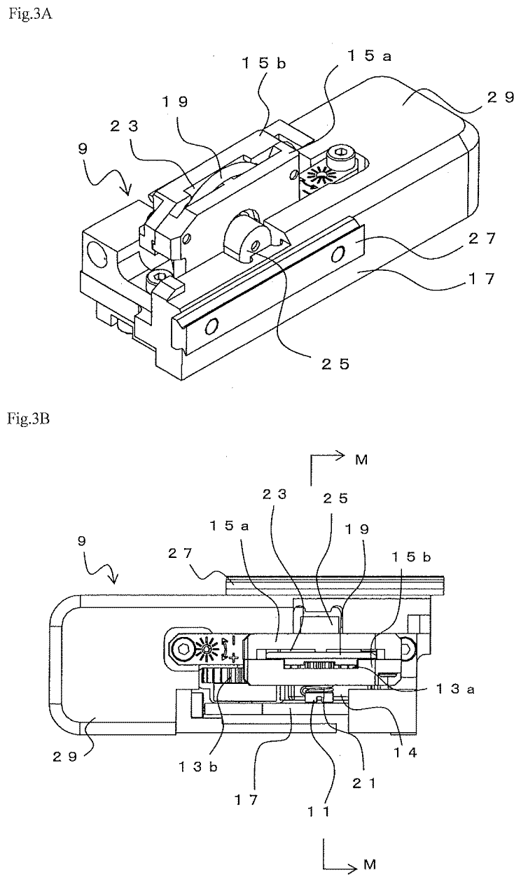

Next, the cutting unit 9 will be described. FIG. 2A is an upper perspective view of the cutting unit 9, FIG. 2B is a lower perspective view of the cutting unit 9, FIG. 3A is a perspective view of a back side of the cutting unit 9, and FIG. 3B is a plan view of the cutting unit 9. The cutting unit 9 includes a base 17, a support part 25 (FIG. 3A and FIG. 3B), a blade member 19, positioning members 15a and 15b, and so on.

A rail 27 is fixed on a side surface of the base 17. The rail 27 can slidably move with respect to a slide block (not shown) that is fixed to the main body 3 of the cutting device 1. That is, the cutting unit 9 is movable in the direction A in FIG. 1 with respect to the main body 3.

The blade member 19 is disposed on an upper part of the cutting unit 9. The blade member 19 is a substantially disc-shaped member and a circumferential part thereof serves as a blade tip. The blade member 19 is stored inside the positioning members 15a and 15b. The positioning members 15a and 15b are members for restricting a position of the blade member 19 and are fixed to the base 17. When the positioning members 15a and 15b are brought to face each other and then joined to each other, a slit 23 is formed at an upper part of the positioning members 15a and 15b. A tip of the blade member 19 protrudes from the slit 23 toward a front surface side (upward) of the positioning members 15a and 15b.

A part of an inner edge of the slit 23 comes into contact with the blade member 19. Thus, the positioning members 15a and 15b serve as a positioning portion for restricting the position of the blade member 19. A method for positioning the blade member 19 in the positioning members 15a and 15b will be described in detail below.

A concave portion is formed on a bottom side of the handling portion 29. In this way, a user can insert fingers into the concave portion of the handling portion 29 to handle the cutting unit 9.

For example, as mentioned above, the handling portion 29 is normally kept protruding from the main body 3 so that operability is good when the main body 3 is placed on a desk to be operated. On the other hand, when the main body 3 is held in hands to be operated, an end of the handling portion 29 is away from the main body 3, which makes operation difficult for users with small hands. However, providing the concave portion, into which fingers can be inserted, on a back surface of the handling portion 29 makes operability excellent even if the main body 3 is held in hands during the operation.

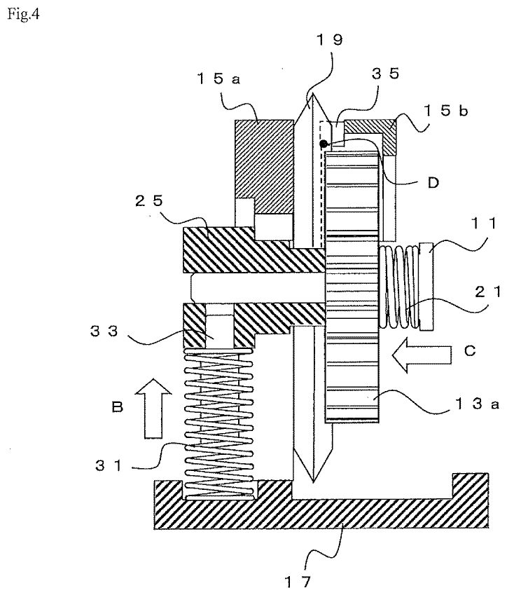

A part of a gear 13b protrudes from a bottom surface side of the cutting unit 9. The gear 13b is an operation unit for rotating the blade member 19. FIG. 4 is a cross-sectional perspective view taken along M-M line in FIG. 3B. A gear 13a is fixed to the blade member 19. The gear 13b meshes with the gear 13a that is fixed to the blade member 19. A rotating mechanism for the blade member 19 by the gears 13a and 13b will be described in detail below.

The support part 25 is fixed on one side of the blade member 19. A pin 33 is connected at a lower part of the support part 25. Also, an elastic member 31, which is a first elastic member, is disposed on an outer periphery of the pin 33. The support part 25 is disposed so as to be changeable in height with respect to the base 17 and supports the blade member 19. The elastic member 31 presses the support part 25 upward with respect to the base 17. Since the positioning members 15a and 15b are fixed to the base 17, the blade member 19 fixed to the support part 25 is pressed toward upper part of the positioning members 15a and 15b (in a direction of the slit 23, i.e. in a direction of the positioning portions) (an arrow B in the drawing).

To adjust a tip position of the blade member 19, heights of the positioning members 15a and 15b with respect to the base 17 may be adjusted. For example, the heights of the positioning members 15a and 15b with respect to the base 17 may be fine-tuned by pushing down the positioning member 15a with a screw provided in a long hole of the positioning member 15a and pushing up the positioning member 15a with a set screw provided in a separately provided screw hole. Thus, the tip position of the blade member 19 with respect to the base 17 can be fine-tuned. The height adjustment for the positioning members 15a and 15b with respect to the base 17 is not always required and, also, another method may be used to adjust the heights of the positioning members 15a and 15b.

At this time, a projection 35 is formed on an inner surface side of the positioning member 15b as a positioning portion for the blade member 19. The blade member 19 is positioned by contacting the projection 35. The positioning of the positioning member 15b by the projection 35 will be described in detail below.

Also, the blade member 19 is disposed so as to be placed between the gear 13a and the support part 25 and is fixed with a fixing screw 11. Also, a part of the positioning member 15a is placed in a gap between the support part 25 and the blade member 19. At this time, an elastic member 21, which is a second elastic member, is disposed in a gap between a head of the fixing screw 11 and the gear 13a.

The elastic member 21 presses the blade member 19 toward the support part 25, in an axial direction of the blade member 19 (the left-right direction in the drawing), and thus the elastic member 21 presses one surface of the blade member 19 (a surface on the left side in the drawing, which is substantially perpendicular to the axial direction except for a tapered portion) against the inner surface of the positioning member 15a (an arrow C in the drawing). Thus, the one surface of the blade member 19 can come into surface-contact with the inner surface of the positioning member 15a that is fixed to the base 17.

By bringing the one surface of the blade member 19 into surface-contact with the inner surface of the positioning member 15a in this way, the position of the blade member 19 in the axial direction (the position in the left-right direction in the drawing) can be positioned with certainty. In addition, since the blade member 19 and the positioning member 15a are pressed against each other through surface-contact, axial misalignment of the blade member 19 (a planar part of the blade member 19 being oriented diagonally with respect to a moving direction (a direction perpendicular to the paper surface) or a height direction of the blade member 19) can be suppressed, and thus the axial direction of the blade member 19 can be maintained perpendicular to either the moving direction and the height direction of the blade member 19.

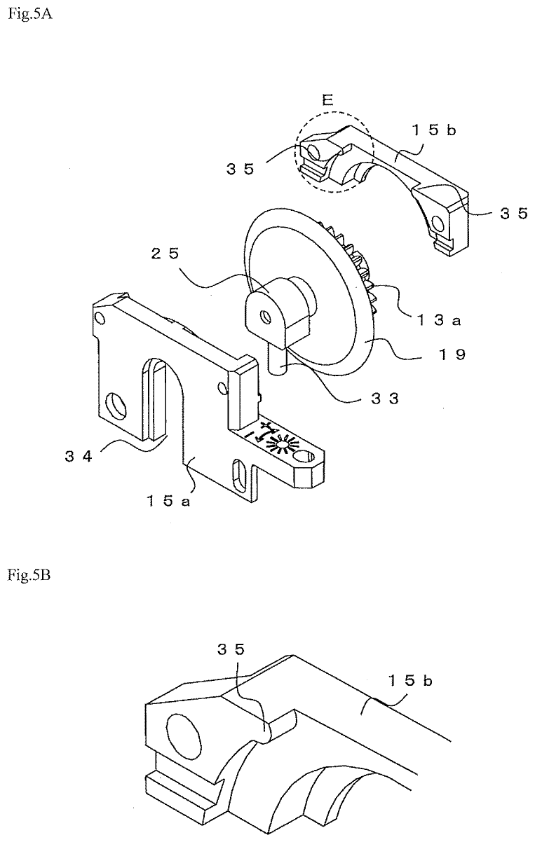

Next, the method for positioning the blade member 19 by the positioning member 15b will be described in detail. FIG. 5A is an exploded perspective view of the positioning members 15a and 15b and the blade member 19. As mentioned above, the inner surface of the positioning member 15a is in surface-contact with the one planar part of the blade member 19. Meanwhile, a pair of the projections 35 are formed at an upper part of the positioning member 15b on a side surface thereof that is opposite to the positioning member 15a.

FIG. 5B is an enlarged view of a section E in FIG. 5A. The projections 35 project toward the inner surface side at the upper part of the positioning member 15b. Thus, when the positioning members 15a and 15b are joined and fixed to each other, the projections 35 are positioned at proximities of both end portions of the slit 23.

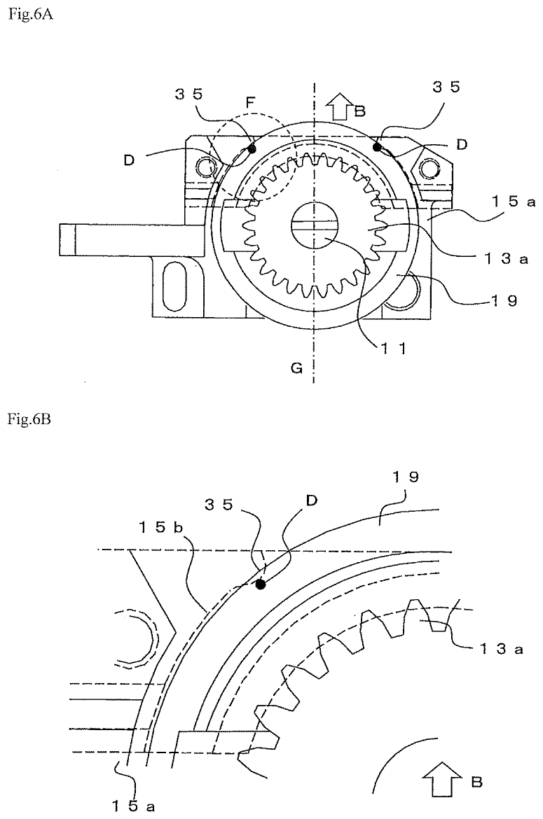

FIG. 6A is a view showing a state in which the blade member 19 is stored inside the positioning members 15a and 15b, and is a perspective view of the positioning member 15b (the positioning member 15b is shown by dotted lines). As shown in FIG. 6A, a pair of the projections 35 projecting to the inner surface side are formed, as the positioning portion for the blade member 19, on one of facing edges of the slit 23 (an edge portion of the inner surface of the positioning member 15b). The projections 35 are formed at two positions with a vertical centerline (axis) of the blade member 19 therebetween.

Also, as mentioned above, the blade member 19 is in a substantially disc shape, and a tapered portion, of which thickness gradually decreases toward the outer periphery, is formed on an outer edge side of the planar part at the center. Thus, when the blade member 19 is pressed upward (a direction of the arrow B in the drawing), the tapered portion of the blade member 19 comes into contact with the projections 35 (a section D in the drawing).

In more detail, a part of the blade member 19 is inserted from a back side of the slit 23, and, with respect to the tapered portions formed on both sides of the blade tip of the blade member 19, one of the tapered portions comes into contact with each of the projections 35 on the inner edge of the slit 23. At this time, the tip of the blade member 19 protrudes toward a surface side of the slit 23.

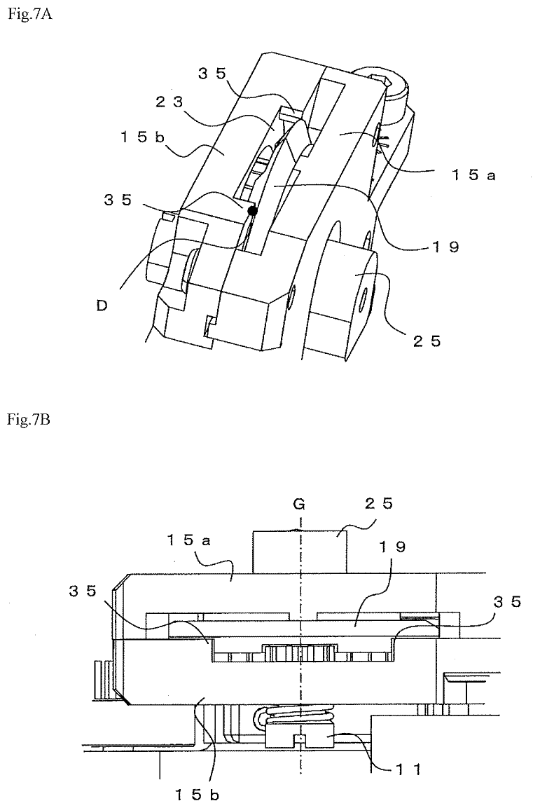

FIG. 6B is an enlarged view of a section F in FIG. 6A. Also, FIG. 7A is an upper perspective view showing a contacting portion between the projections 35 and the blade member 19, and FIG. 7B is an upper plan view of the blade member 19.

As shown in FIG. 6B, when viewed from the axial direction of the blade member 19, tips of the projections 35 (the contacting portions with the blade member 19) are formed arc-shaped. Also, since the tapered portion of the blade member 19 is formed in a circular shape along the outer periphery, the arc portions of the projections 35 are in point-contact with the tapered portion of the blade member 19. That is, the blade member 19 is pressed upward (toward the slit 23) by the elastic member 31, and the tapered portion of the blade member 19 comes into contact with the projections 35, thereby restricting the further upward movement. As a result, the blade member 19 can be positioned in the height direction.

At this time, as shown in FIG. 6A, the pair of projections 35 are disposed at positions symmetrical to a centerline extending in the height direction of the blade member 19 (a vertical centerline passing through the axis, i.e. G in the drawing). That is, the blade member 19 is positioned, with respect to the height direction, at two points when viewed from above. By performing the positioning at the two points of the positions that are predetermined distance away from the centerline (axis) in this way, the blade member 19 can be positioned also with respect to the moving direction (the left-right direction in the drawing).

For example, when the positioning member is brought into surface-contact with the tapered portion of the blade member 19, depending on accuracy of the positioning members 15a and 15b and fixing accuracy, there may be cases where the positioning member does not come into complete surface-contact, but is misaligned and comes into contact at an angle, and this may change the height of the blade tip. Also, even if both the positioning members 15a and 15b are to perform positioning in a height direction by point-contact, there may be cases where heights of positioning portions on both sides may not match and, because of the point-contact at one point on each side, the axis of the blade member may be misaligned and the blade member may not be butted perpendicularly against the optical fiber.

In contrast, in the present embodiment, the one surface of the blade member 19 is in surface-contact with the inner surface of the positioning member 15a and, at the same time, the elastic member 31 presses the blade member 19 toward the slit 23 so that the tapered portion on the other surface of the blade member comes into point-contact with the projections 35 and the blade member 19 is positioned. In this way, even if a slight misalignment occurs when joining the positioning members 15a and 15b, the blade member 19 still can be positioned with high precision since only the positioning member 15b performs the positioning of the blade member 19 in the height and moving directions and the positioning member 15a suppresses misalignment (tilting) of the axis of the blade member 19.

Here, as shown in FIG. 5A, a cutout portion 34 is formed in the positioning member 15a. When the blade member 19 is placed between the positioning members 15a and 15b to be attached, the support part 25 is disposed so as to fit into the cutout portion 34. Also, a flat surface is formed in a vertical direction on each side surface of the support part 25, and the cutout portion 34 is formed straightly in the vertical direction at a part corresponding to the flat surfaces of the support part 25. Thus, the support part 25 can slide substantially straightly in the vertical direction while being fitted into the cutout portion 34.

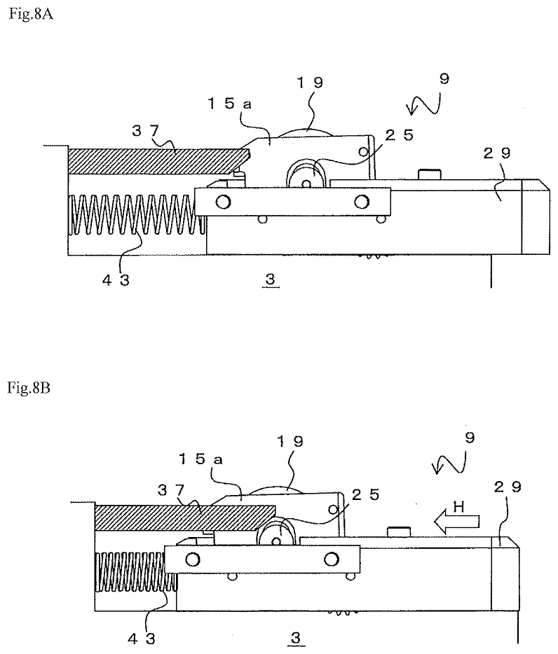

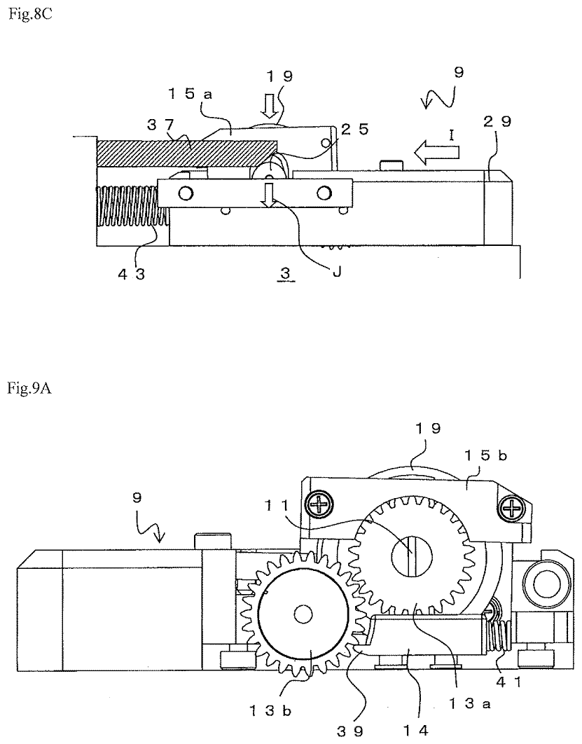

Next, rotational operation of the blade member 19 will be described. FIG. 8A to FIG. 8C are views showing motions of the cutting unit 9 (the support part 25) with respect to the main body 3. A support part lowering mechanism 37 is fixed to the main body 3. The support part lowering mechanism 37 is fixed to the main body 3 at a predetermined position.

Also, an elastic member 43 for pressing the cutting unit 9 is disposed on the main body 3. The cutting unit 9 receives force from the elastic member 43 in a direction in which the cutting unit 9 is pushed out from the main body 3. Thus, as shown in FIG. 8A, the handling portion 29 of the cutting unit 9 protrudes from the main body 3 in a normal state. In such the state, the support part lowering mechanism 37 is not in contact with the cutting unit 9.

When the handling portion 29 is pushed into the main body 3 from such the state as shown in FIG. 8B (an arrow H in the drawing), the cutting unit 9 is kept being pushed inside the main body 3 by a locking portion, which is not shown in the drawing. That is, the handling portion 29 can move the cutting unit 9 (the support part 25) with respect to the main body 3. When the cutting unit 9 is pushed into the main body 3 by a predetermined amount or more, the locking portion locks the cutting unit 9 in such the position, holding the cutting unit 9 in the state of being pressed by the elastic member 43. As mentioned above, if the lid portion 5 (FIG. 1) is closed in such the state, the locking portion is released in conjunction with closing motion of the lid portion 5, and the cutting unit 9 is pushed out by the elastic member 43, returning to the state shown in FIG. 8A. At this time, as the blade member 19 moves, the blade member 19 scratches the optical fiber, applying stress to the optical fiber and thus cutting the optical fiber.

Here, a standby position before cutting (i.e., the state in which the cutting unit 9 is pushed into the main body 3) as shown in FIG. 8B is defined as a first position of the cutting unit 9 (the support part 25 of the cutting unit 9) with respect to the main body 3. Also, a position after cutting (i.e., the state in which the cutting unit 9 is pushed out of the main body 3) as shown in FIG. 8A is defined as a second position of the cutting unit 9 (the support part 25 of the cutting unit 9) with respect to the main body 3. That is, the cutting unit 9 is movable between the first position and the second position, and the handling portion 29 can push the cutting unit 9 into the main body 3 from the second position to the first position.

As shown in FIG. 8A and FIG. 8B, the support part lowering mechanism 37 and the support part 25 do not interfere with each other in the first position and the second position of the cutting unit 9. That is, since the support part 25 is pressed upward (toward the side of the positioning portion) by the elastic member 31 (FIG. 4), the blade member 19 is in a state being pressed against the projections 35 of the positioning member 15b.

On the other hand, as shown in FIG. 8C, the cutting unit 9 can be pushed further into the main body 3 from the state of FIG. 8B (an arrow I in the drawing). That is, there is a slight amount of play between a maximum pushed-in position of the cutting unit 9 and the locked position (the first position) of the cutting unit 9.

If the handling portion 29 is further pushed in from the first position, resisting the pressing force by the elastic member 43, the support part 25 comes into contact with the support part lowering mechanism 37. At this time, if an upper surface of the support part 25 (an upper part of the above-mentioned flat surfaces on the sides) has an arc shape and the support part lowering mechanism 37 has a tapered surface where an end surface position becomes higher toward a tip thereof, for example, the support part 25 is pushed down (an arrow J in the drawing) due to the contact between the support part 25 and the support part lowering mechanism 37. That is, the support part lowering mechanism 37 provided on the main body 3 serves as a support part lowering mechanism for lowering the support part 25. When the handling portion 29 moves the support part 25 by a predetermined distance or more, the support part lowering mechanism 37 comes into contact with a part of the support part 25 so as to push down the support part 25 in a direction opposite to the positioning portion.

At this time, as mentioned above, the flat surfaces on the both sides of the support part 25 move along straight-lined portions of the cutout portion 34 formed in the positioning member 15a, and thus the blade member 19 can slide straight down without tilting obliquely. That is, the positioning member 15a has a guide mechanism that allows the support part 25 to move straight down while maintaining its posture without tilting. The structure of the guide mechanism is not particularly limited thereto.

As above, the support part 25 can move between the first position, which is a standby position before cutting, and the second position, which is the position after cutting, and the handling portion 29 can push the support part 25 from the second position to the first position into the main body 3. When the handling portion 29 moves the support part 25 excessively beyond the first position, the support part lowering mechanism comes into contact with the part of the support part 25 and can push down the support part 25.

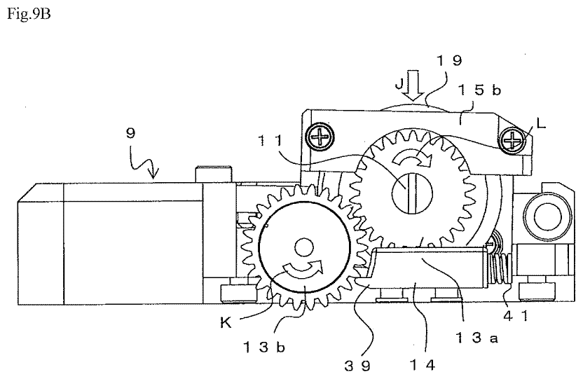

FIG. 9A is a view showing a positional relationship between the blade member 19 and the gears 13a and 13b, etc. in the first position (FIG. 8B), and FIG. 9B is a view showing a positional relationship between the blade member 19 and the gears 13a and 13b, etc. in a state in which the support part 25 is moved beyond the first position (FIG. 8C).

As mentioned above, the gear 13a is fixed to the blade member 19. Also, the gear 13a meshes with the gear 13b fixed to the base and a part of the gear 13b is exposed from the main body. That is, a rotation mechanism for rotating the blade member 19 includes the gear 13a fixed to the blade member 19 and the gear 13b fixed to the base, and the gear 13a and the gear 13b mesh with each other such that the gear 13b can rotate the gear 13a.

The gears 13a and 13b mesh with each other both in the state in which the support part 25 is not lowered (FIG. 9A) and in the state in which the support part 25 is lowered by the support part lowering mechanism (FIG. 9B). That is, the gear 13b does not rotate freely independent of the gear 13a, and the gears 13a and 13b are always interlocked.

As mentioned above, when the support part 25 is not lowered (FIG. 9A), the blade member 19 is pressed against the positioning portion and thus rotation of the blade member 19 is restricted by friction with the projections 35. On the other hand, when the support part 25 is lowered by the support part lowering mechanism (FIG. 9B), the contact between the tapered portion of the blade member 19 and the positioning member 15b (the projections 35) is released. Thus, the friction between the blade member 19 and the projections 35 disappears, making it possible to rotate the blade member 19 by the rotation mechanism. Thus, when the gear 13b is operated and rotated (an arrow K in the drawing), the blade member 19 can be rotated together with the gear 13a (an arrow L in the drawing).

An elastic member 41 presses a rotation restricting member 14 against the gear 13b. At a tip end portion of the rotation restricting member 14, a hook 39 that is to mesh with the gear 13b is formed. The rotation restricting member 14 can restrict a rotation direction of the gear 13b to a predetermined direction. That is, the rotation restricting member 14 serves as a ratchet for the gear 13b. Alternatively, the rotation restricting member 14 may be pressed against the gear 13a to restrict the rotation direction of the gear 13a.

The rotation restricting member 14 can also regulate a rotational position for each tooth pitch of the gears 13a and 13b. That is, when the gear 13b is rotated, the elastic member 41 pushes the hook 39 of the rotation restricting member 14 into the next gap between the teeth of the gear 13b every time the hook 39 passes over a tooth of the gear 13b, and thus a user can acknowledge that a predetermined amount has been rotated for each tooth pitch.

At this time, the gear 13b may be provided with a display unit (not shown) for indicating the rotational position of the gear 13b (the blade member 19). In this way, the user can acknowledge the current rotational position of the blade member 19 (the position protruding from the slit). Thus, the user can acknowledge how many rotations are left until the blade member 19 completes one revolution and know the timing for replacing the blade member 19.

As described above, according to the embodiments of the present invention, by providing the elastic member 31 that presses the blade member 19 to the positioning member 15b, which restricts the height of the blade member 19, the height of the tip of the blade member 19 protruding to the surface side of the slit 23 can be kept constant even if a rotational axis of the blade member 19 is eccentric. That is, the positional relationship between the optical fiber and a blade portion of the blade member 19 can be kept constant.

Also, the elastic member 21 allows the blade member 19 to come into surface-contact with the inner surface of the positioning member 15a. This can restrict the orientation of the axis of the blade member 19 with certainty. That is, the orientation of the blade portion of the blade member 19 with respect to the optical fiber can be kept constant.

In this way, the blade member 19 can scratch the optical fiber under fixed conditions at all times. As a result, it is possible to suppress occurrence of variation in cross-sectional shapes or poor cutting of the optical fiber caused by variation in the depth of the scratch. Thus, cutting quality of the optical fiber can be improved.

Also, precision in machining the rotational axis of the blade member 19 is not required to be so high, and this facilitates manufacturing of the blade member 19 and cuts down machining cost of the blade member 19.

Also, by moving the support part 25, the support part 25 can come into contact with the support part lowering mechanism 37 and the support part 25 can be pushed down in the direction opposite to the projections 35. As a result, the contact between the blade member 19 and the projections 35 is released, thereby reducing rotation resistance of the blade member 19. This facilitates rotation of the blade member 19. Thus, the circumferential position of the blade member 19 that comes into contact with the optical fiber can be easily changed.

Also, the rotation restricting member 14 is pressed against the gear 13b for rotating the blade member 19 so that the gear 13b can always rotate only in one direction. This prevents the gear 13b from being accidentally rotated in the reverse direction and replacing with the old blade tip position of the blade member 19.

Also, the gears 13a and 13b are always kept in the meshed state and thus the gear 13b never rotates freely. Thus, by providing the display unit for indicating the rotational position of the blade member 19 on the gear 13b, the user can easily know the currently used blade tip position of the blade member 19.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

For example, as long as the blade member 19 can be pressed against the positioning members 15a and 15b in the predetermined direction, arrangements of the elastic members 21 and 31 and a structure of the support part 25 etc. are not limited to the illustrated examples. Also, if it is possible to position the blade tip by pressing the tapered portion of the blade member 19 to the positioning portion, such the positioning structure is not limited to the above-mentioned example. For example, the positioning portion may be in point-contact or surface-contact with the tapered surfaces on both sides of the blade member 19.

Also, although the elastic member 21 disposed at the axis of the blade member 19 presses the blade member 19 against the inner surface of the positioning member 15a to be in surface-contact, alternatively, the blade member 19 may be fastened by another fixing member or the like, without using the elastic member 21, so as to bring the blade member 19 into surface contact with the inner surface of the positioning member 15a.

Also, although the pair of the projections 35 are disposed symmetrically to the centerline of the blade member 19, the positions of the projections 35 may not necessarily be symmetrical as long as positioning of the blade member 19 is possible.

Also, the support part lowering mechanism for releasing the contact between the blade member 19 and the positioning portion is not limited to the above-mentioned example and may be an independent mechanism that is not in conjunction with the movement mechanism of the cutting unit 9.

What is claimed is:

1. A cutting device for cutting an optical fiber, the cutting device comprising:
a base;
a disc-shaped blade member;
a positioning member that is provided on the base and restricts a position of the blade member;
a support part that is disposed so as to be changeable in height with respect to the base and supports the blade member;
a first elastic member that presses the support part to a positioning portion of the positioning member with respect to the base;
a support part lowering mechanism that is provided on the main body and can push down the support part in a direction opposite to the positioning portion; and
a rotation mechanism that allows the blade member to rotate, wherein:
the positioning member includes a slit;
the blade member is stored inside the positioning member;
the first elastic member presses the blade member toward the slit so that a tapered portion of the blade member is positioned by coming into contact with the positioning portion on an inner surface side of the slit;
a tip of the blade member protrudes to a surface side of the slit; and
when the support part lowering mechanism lowers the support part to release the contact between the tapered portion of the blade member and the positioning portion, the rotation mechanism can rotate the blade member.

2. The cutting device according to claim 1, the cutting device further comprising a handling portion for moving the support part with respect to the main body, wherein when the handling portion moves the support part by a predetermined distance or more, the support part lowering mechanism comes into contact with a part of the support part so as to push down the support part.

3. The cutting device according to claim 2, wherein:
the support part is movable between a first position, which is a standby position before cutting, and a second position, which is a position after cutting, and the handling portion can push the support part into the main body from the second position to the first position; and
when the handling portion excessively moves the support part beyond the first position, the support part lowering mechanism comes into contact with a part of the support part so as to push down the support part.

4. The cutting device according to claim 1, wherein:
the rotation mechanism includes a first gear that is fixed to the blade member and a second gear that meshes with the first gear and can rotate the first gear; and
the first gear and the second gear mesh with each other whether the support part is lowered or not lowered by the support part lowering mechanism.

5. The cutting device according to claim 4, the cutting device further comprising a rotation restriction member that is to be pressed against the first gear or the second gear, the rotation restriction member including a hook that meshes with the first gear or the second gear, wherein the rotation restriction member can restrict a rotation direction of the first gear or the second gear to a fixed direction.

6. The cutting device according to claim 5, wherein the rotation restriction member can define a rotational position for each tooth pitch of the first gear or the second gear, and the second gear includes a display unit for indicating the rotational position of the blade member.

7. The cutting device according to claim 1, the cutting device further comprising a second elastic member that presses the blade member toward the support part in an axial direction of the blade member, wherein:
a projection is formed as the positioning portion on one of facing edges of the slit so as to project toward an inner surface side, and the projection is formed at two places with an axis of the blade member therebetween when viewed from above;
the second elastic member presses the blade member such that one surface of the blade member is in surface-contact with the inner surface of the positioning member; and
the first elastic member presses the blade member toward the slit so that a tapered portion on the other surface of the blade member is positioned by being in point-contact with each projection.

8. The cutting device according to claim 1, the cutting device further comprising a guide mechanism that allows the support part to move downward while maintaining a posture thereof when the support part lowering mechanism lowers the support part.
